(19) United States
(12) Patent Application Publication
(10) Pub. No.: US 2009/0249350 A1
(43) Pub. Date: Oct. 1, 2009

(54) Resource Allocation Through Negotiation

(75) Inventors: John W. Senders, Toronto (CA); Abigail Sellen, Cambridge (GB)

Correspondence Address: LEE & HAYES, PLLC, 601 W. RIVERSIDE AVENUE, SUITE 1400, SPOKANE, WA, 99201, US

(73) Assignees: John W. Senders, Toronto (CA); Microsoft Corporation, Redmond, WA (US)

(21) Appl. No.: 12/059,793

(22) Filed: Mar. 31, 2008

(51) Int. Cl. G06F 9/50

(52) U.S. Cl. 718/104

(57) ABSTRACT

Improved resource allocation methods which use negotiation are described. In an embodiment, a request for access to a resource by a service user is received and an available access slot is allocated, where the slot may be a time or a position in a queue. This allocated slot may or may not meet the service user's requirements and if this allocated time does not meet the service user's requirements, an access time which does meet the requirements but is already allocated to another service user is identified. A message is sent to the user device associated with the other service user requesting a change in allocated access time. If the change is accepted the allocated times are swapped between the two service users.

### BACKGROUND

There are many situations where a service user must wait in a queue or make an appointment to access a resource, such as a doctor, bank manager, taxi, washing machine or other piece of equipment etc. For the service user (or customer), the waiting time whilst in the queue or the difficulty in finding a suitable available appointment can lead to frustration and is an inefficient use of their time. The time spent in the queue is lost time to the service user. To the service provider, however, which may be the bank, the doctors surgery, taxi company etc, such queues have the advantage that their resource (be it a person or piece of equipment) is used efficiently and the time when it is idle is kept to a minimum. Service providers may control the release of appointments to ensure that those with an urgent need can obtain appointments at short notice; however, this means that it is hard to make longer term bookings (e.g. a month in advance) and often results in a first come first served approach, rather than being based on need.

The embodiments described below are not limited to implementations which solve any or all of the disadvantages of known resource allocation and queuing systems.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Improved resource allocation methods which use negotiation are described. In an embodiment, a request for access to a resource by a service user is received and an available access slot is allocated, where the slot may be a time or a position in a queue. This allocated slot may or may not meet the service user's requirements and if this allocated time does not meet the service user's requirements, an access time which does meet the requirements but is already allocated to another service user is identified. A message is sent to the user device associated with the other service user requesting a change in allocated access time. If the change is accepted the allocated times are swapped between the two service users.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is schematic diagram of a system for resource allocation;

FIG. 2 is a flow diagram of an example method of operation of a client application running on a user device;

FIG. 3 is a flow diagram of an example method of operation of a server;

FIGS. 4-6 show flow diagrams of example implementations of method blocks from FIGS. 2 and 3 in more detail;

FIG. 7 is a flow diagram of another example method of operation of a server;

FIG. 8 shows a flow diagram of an example implementation of a method block from FIG. 7 in more detail;

FIG. 9 is a flow diagram of a further example method of operation of a server;

FIGS. 10-12 show flow diagrams of example implementations of method blocks from FIGS. 3, 7 and 9 in more detail;

FIG. 13 is a flow diagram of another example method of operation of a server; and

FIGS. 14 and 15 illustrate exemplary computing-based devices in which embodiments of the methods described herein may be implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

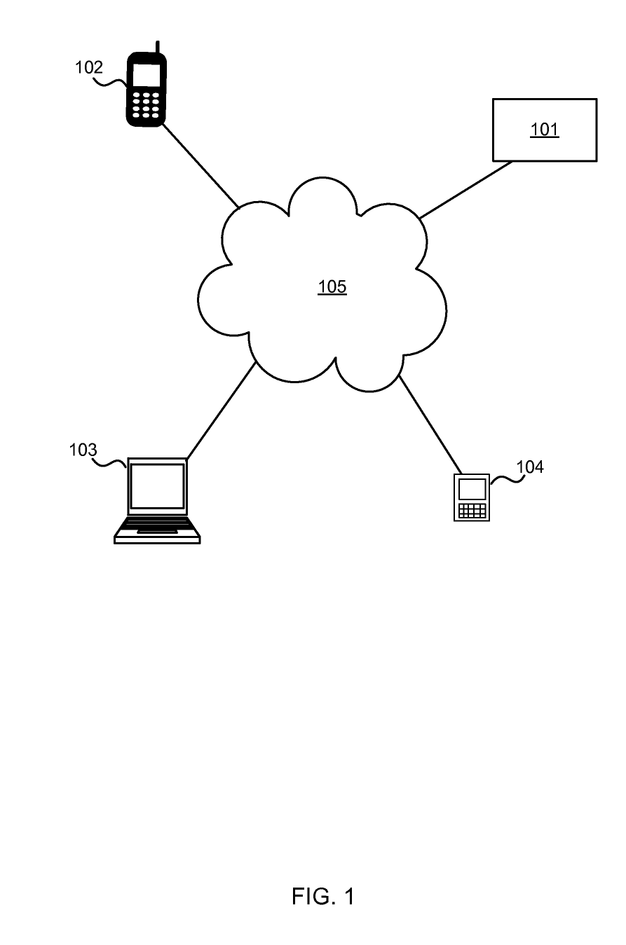

FIG. 1 is schematic diagram of a system 100 for resource allocation. The system comprises a server 101 which is connected to a number of user devices 102-104 via a network 105. For the purposes of the following description the operation of the system 100 is described as having a client-server configuration, with client applications running on each user device 102-104 which communicate with the server 101. Alternatively, all the operations could run on the server 101 with service users accessing the server via their user devices 102-104 using a standard application (e.g. a browser) and an appropriate interface provided by the server 101, such as a web interface.

The term ‘client’ is used herein to refer to a client application running on a user device in a client-server architecture, although as described above this is only one example of a suitable system architecture. To avoid any confusion, customers or users of services provided by a service provider are referred to herein as 'service users'.

The server 101 may be operated by a service provider which provides time based resources to service users, alternatively, the server 101 may be operated by a third party on behalf of one or more service providers. Where the server is operated by a third party, the third party may charge the service provider for providing this service. The server manages access to one or more time based resources by multiple service users. There are two kinds of service providers: time-appointment (TA) and open access (OA), and the queues operate differently for each type. An open access service provider, such as a bank teller, accepts each new service user on arrival and the service user waits according to the length of the queue at the moment of joining and the statistics of the queue at that time. A time-appointment service provider, such as a doctor, dentist or optometrist, specifies a time to a service user based on the times available and a time is jointly selected for the service user to join the queue.

The user devices 102-104 may be any type of user device, such as a mobile telephone 102, laptop computer 103 or other PC, personal digital assistant (PDA) 104 etc. The network 105 may comprise the internet, an intranet or any other network. It will be appreciated that there may be more or fewer user devices which communicate with the server 101 and that there may be additional elements within the system which are not shown in FIG. 1. In some examples, there may be more than one server 101.

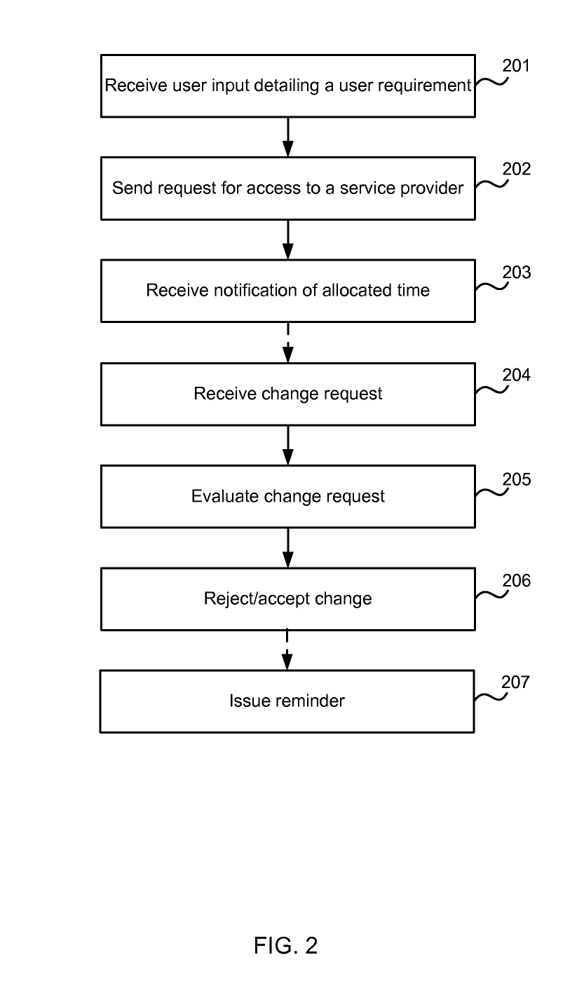

FIG. 2 is a flow diagram of an example method of operation of a client application running on a user device. The client application communicates with the server 101 and can be used to request access to a time based resource. The time based resource may comprise time based access to any resource, such as a time based service (e.g. booking a home cleaning service), an appointment to see a person (e.g. a doctor or financial advisor), or use/loan of a piece of equipment (e.g. a washing machine or power tool), or access to a timed resource, such as an airplane, train, bus etc. The client application receives a user input detailing a service user's requirement for a time based resource (block 201) and based on this user input generates and sends a request for access to the time based resource to the server (block 202). The user input may be received (in block 201) through a voice command, through a keyboard or touch sensitive display, by stylus input or through any other user input means. In response to the request, the client application receives notification of an allocated time (e.g. 0900 or 0900-0905, which may also be referred to as a ‘time slot’) from the server (block 203).

Subsequently, the client application may receive a request from the server 101 to change the allocated time (block 204). This request is evaluated by the client application (block 205) and as described in more detail below, the evaluation may be performed by the client application autonomously or may require user input. Following the evaluation, a message is sent by the client application indicating that the change is rejected or accepted (block 206). The client application may provide a reminder to the service user (block 207) in advance of the allocated time. This reminder may be an audible, visual, vibrating or other type of reminder. Where the service user has an electronic calendar, the notification received (in block 203) and any reminders (in block 207) may be passed to the electronic calendar.

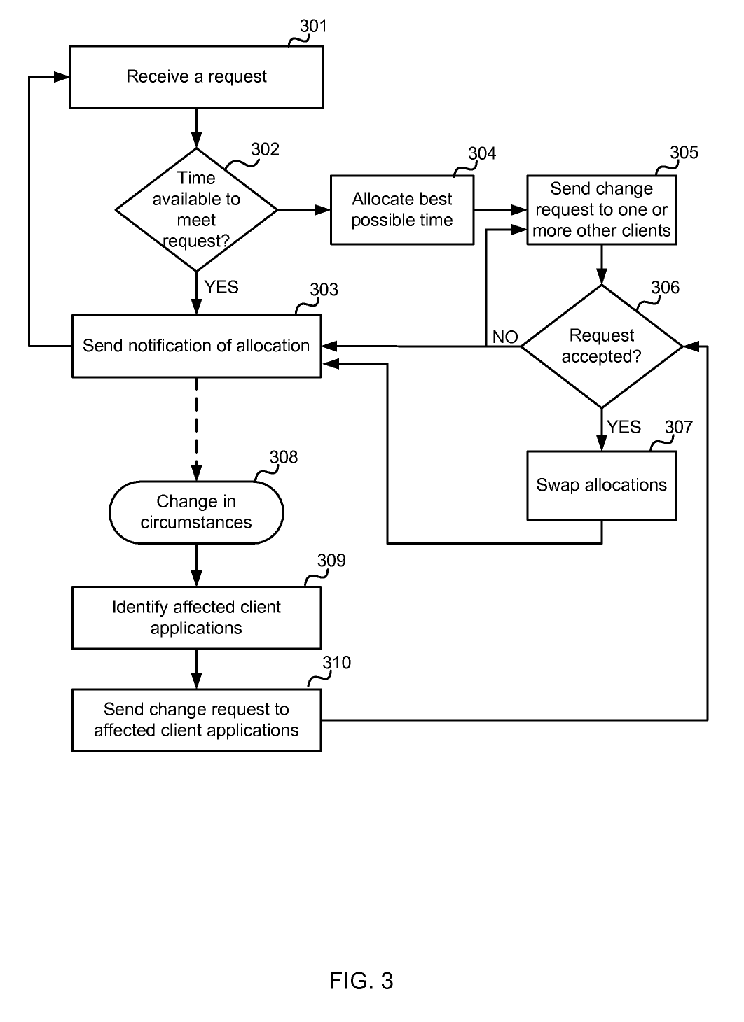

FIG. 3 is a flow diagram of an example method of operation of a server 101. On receipt of a request (in block 301) from a client application, the server identifies whether there is an available time (or time slot) for the particular resource which satisfies the service user's requirements, as identified from the contents of the request, (block 302). The contents of the request may be referred to as ‘user constraints’. The particular resource may be identified in the request, for example where the server provides access to more than one resource. If a suitable time is available (‘Yes’ in block 302), a notification is sent to the client application including details of the allocated time (block 303). Alternatively, where there is no available time which satisfies the service user's request (‘No’ in block 302), the server allocates the best possible time to the client application (block 304), which may, for example, be the next available time or the time which most closely meets the service user requirements.

The server then performs negotiation between client applications in an attempt to fully satisfy the new user request (received in block 301). The negotiation comprises sending change requests to one or more other client applications (block 305). If none of the change requests are accepted (‘No’ in block 306, i.e. no messages are received from client applications indicating an acceptance of the change by the client application and/or the service user), the server may send additional change requests (block 305) or may notify the client application of the original time allocation (block 303, with the time as allocated in block 304). If a change request is accepted by another client application, either autonomously or with input from the service user, (‘Yes’ in block 306), the allocated times of the client application and the other client application are swapped (block 307) and a notification is sent to the client application detailing the allocated time (block 303). A notification may also be sent to the other client application confirming the new, swapped time allocation (also in block 303). The process (blocks 301-307) may then be repeated when a new request is received from a client application.

Subsequently, there may be a change in circumstances in relation to the provision of the time based resource (block 308). This change in circumstances may be a cancellation by a service user, a period of unavailability of the resource (e.g. due to sickness or equipment failure), additional availability (e.g. due to additional personnel or equipment being available) etc. The server identifies those client applications affected by the change (block 309) and sends change requests to those affected applications (block 310). If the change request is accepted (‘Yes’ in block 306), time allocations may be swapped (in block 307) and the client application notified of the new allocation (in block 303). The swapping may be between service users and/or to new times not previously allocated. If change requests are not accepted (‘No’ in block 306), a notification confirming the original allocation may be sent (in block 303) and/or change requests may be sent to additional client applications (in block 305). In some cases, the changes may be required by the service provider (e.g. where the change in circumstances results in the resource not being available) and if the change is not accepted, this may result in the original allocation being cancelled and no alternative being provided.

The individual method blocks shown in FIGS. 2 and 3 are described below in more detail. It will be appreciated that a client or server may perform a subset of the method blocks shown in FIGS. 2 and 3 and/or a client or server may perform additional method blocks not shown in FIGS. 2 and 3. As described above, the client-server architecture described is just one possible architecture and therefore the server may perform blocks shown in both FIGS. 2 and 3.

The methods of operation of the client application and the server, as described above, provide an improved resource allocation method. By considering more than one request (e.g. through the change request mechanism), the resulting allocation may be more efficient both for the service provider and for the service users. The allocation of resources to service users may be optimized based on one or more different costs, such as the societal cost (i.e. the time costs to all the service users), the direct cost (i.e. to the service provider of providing the service), the individual user cost (e.g. the wasted time a service user spends queuing) etc. In an example, the overall cost to all involved may be reduced, rather than just considering the cost to the service provider. Furthermore, where circumstances change, the time allocation can be adjusted to improve the overall efficiency for service users and the service provider.

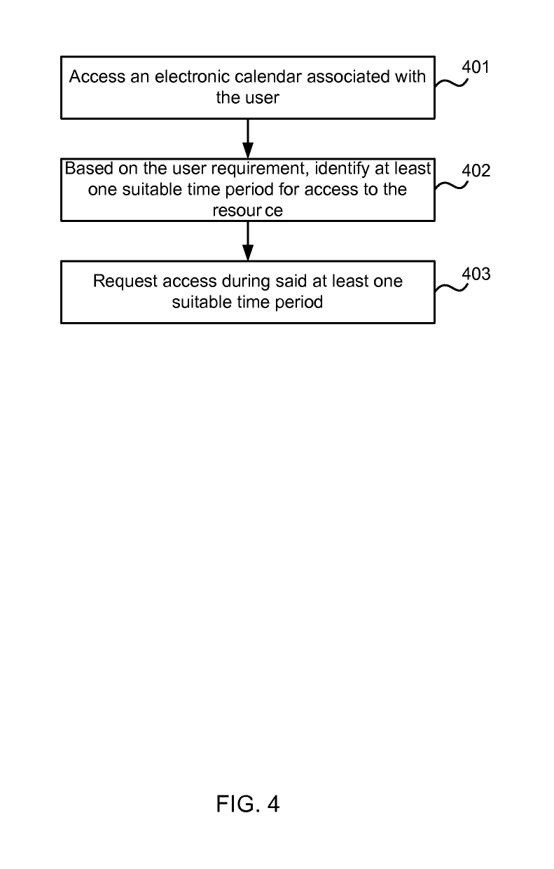

The user input, received in block 201, which details a service user's requirement for a time based resource may comprise one or more of:
details of the time based resource
time/date information, such as a preferred time/date to access the resource or a deadline by which the resource needs to be accessed. In some examples, more than one set of time/date information may be provided along with details of an order of preference.
a priority or urgency rating, which is used to indicate the importance to the level of need of the service user.
a price or premium (e.g. a 10% premium on any fee for the resource) which the service user is prepared to pay in order to obtain the requested time slot. This may comprise a token or voucher that the service user is prepared to redeem.
a flexibility indicator, which determines whether a time slot which is allocated in response to the request may subsequently be changed to accommodate other service users (e.g. as in blocks 208-212). There may be parameters associated with the flexibility indicator, or levels of flexibility indicated, which may indicate the maximum number of times the request can be changed or the amount of notice required for any change etc.
a discount (e.g. a 5% discount on any fee for the resource) or other incentive (e.g. priority on access to the resource on subsequent occasion) or reward that the user requests in return for any change in allocated time slot.
   In addition to, or instead of, obtaining detailed time/date information from the user input, the client application may interface to a calendar application which is used by the service user and which may be running on the user device or on a server which is accessible by the client application. For example, the service user may use Microsoft® Office Outlook® or a web based calendar and the client application may interface to the calendar to determine the service user's availability, as shown in FIG. 4 and described below.

FIG. 4 shows a flow diagram of an example implementation of block 202 of FIG. 2 in more detail. The client application accesses electronic calendar data associated with the service user (block 401) and based on the user requirement (received in block 201) and the calendar data (from block 401), the application identifies at least one suitable time period for accessing the required time based resource (block 402). The time period(s) identified may be longer than the actual required time to access the time based resource e.g. a service user may require a 10 minute doctors appointment and a time period of several hours which are free (as identified using the calendar data) may be identified. Access is then requested during one or more of the identified time periods (block 403).

The request sent by the client application (in block 202) may include a number of user constraints, one example of which is the identified time periods described above. Other aspects of the user input may be included as constraints within the request, such as one or more of the priority/urgency rating, a flexibility indicator and details of any price/premium/discount etc provided by the service user.

When a change request is received by a client application (in block 204), the request is evaluated (block 205). This evaluation may be performed by the client application autonomously or may be based on user input. Where the decision is made autonomously, this may be based on calendar information for the service user (e.g. as accessed in a similar manner to that described above in relation to block 401) or based on the earlier user input (in block 201) or on other information available to the client application. Where the evaluation is based on user input, the client application may present the change request to the service user (e.g. via a suitable graphical user interface) and receive a user input indicating that the request should either be accepted or rejected. Where the system does not use a client-server architecture, this change request may be sent via email, SMS (short message service), instant messenger or any other messaging technology. Notifications and/or reminders may be sent in a similar manner. Having evaluated the request, as described above, the client application accepts or rejects the change request by sending a message to the server (in block 206).

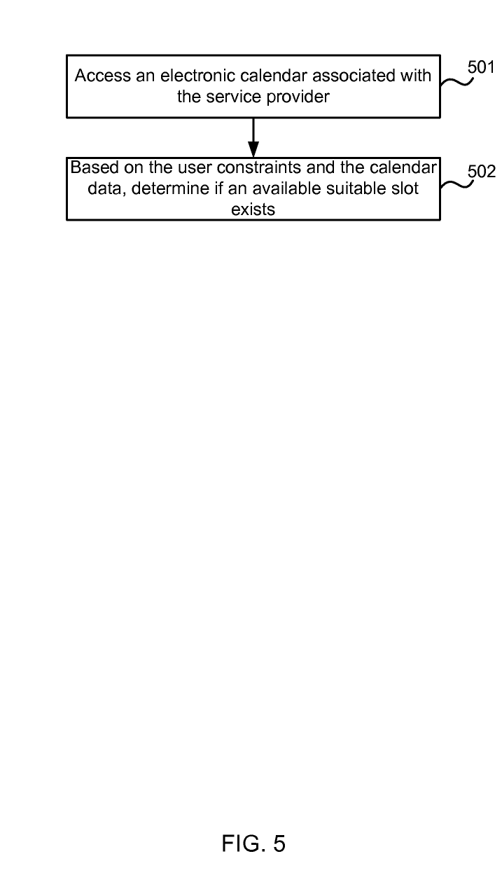

FIG. 5 shows a flow diagram of an example implementation of block 302 of FIG. 3 in more detail. In order to determine if there is a time available to meet a request (received in block 301), the server accesses electronic calendar data for the service provider (block 501) and based on user constraints (as included within the request) and the calendar data, determines if time is available (i.e. unallocated) to meet the request (block 502). The calendar data for the service provider may be stored on the server 101 or may be stored elsewhere.

As described above, the request sent by the client application (in block 202) and received by the server (in block 301) may include a number of user constraints and these user constraints may include a flexibility parameter or flexibility flag. These constraints, and in particular any flexibility indicator, may be used by the server in determining which client applications to send change requests to (in block 305). Other constraints, such as premium, discount, priority/urgency rating etc may also be used and a number of examples are described below.

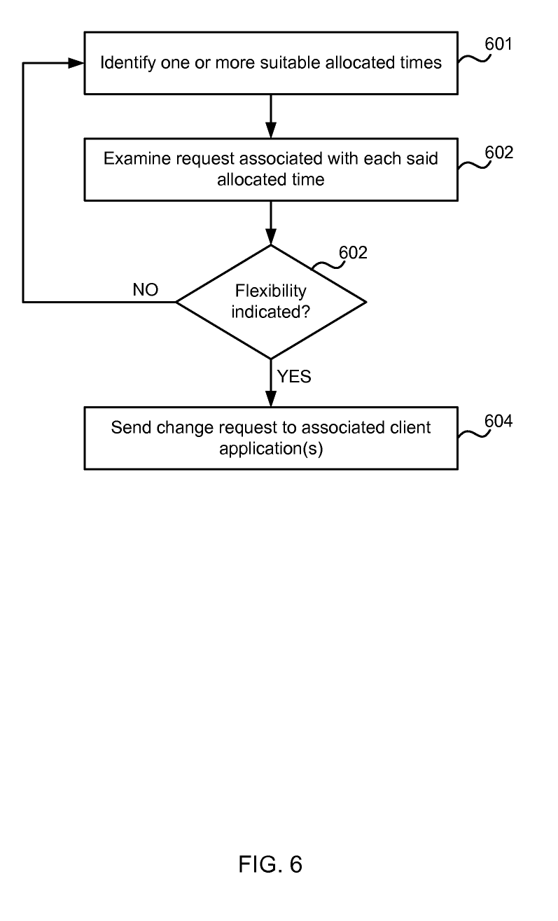

FIG. 6 shows a flow diagram of an example implementation of block 305 of FIG. 3 in more detail. The server identifies one or more times which satisfy the request (received in block 301) but which are already allocated to service users in response to previous requests (block 601), i.e. which are unavailable. This determination of requests (in block 601) may be based on optimization of one or more different costs, as described above. The constraints within each request associated with an identified suitable, but allocated, time are examined (block 602) to determine if flexibility is indicated. If flexibility is indicated (‘Yes’ in block 603), a change request is sent to the corresponding client applications (block 604). Where flexibility is not indicated in any of the requests corresponding to identified suitable, but allocated, times (‘No’ in block 603), additional suitable allocated times may be identified (in block 601) and the process repeated.

In the method shown in FIG. 6, one or more suitable unavailable times may be identified (in block 601) and one or more change requests may be sent out (in block 604). In an example, the suitable unavailable times may be ranked in terms of suitability and change requests may be sent out sequentially to client applications to which the unavailable times have been allocated in order of suitability. In identifying which client applications to send a change request to, other constraints may be considered in order to identify a client application whose request can still be satisfied if its allocated time is swapped.

The process of re-allocating slots (in blocks 305-307) may affect two service users (e.g. as shown in FIG. 3) or may affect multiple service users. For example, where there are three service users (as shown in FIG. 1), the request may be sent by service user A (in block 202) and result in service user A taking a time allocated previously to service user B. Service user B may then be allocated the time originally allocated to service user A (in block 304) or may be allocated a time slot allocated to service user C, and service user C may be allocated the time originally allocated to service user A (in block 304). Where multiple service users are affected, the re-allocation may be performed by repeated swapping of pairs of time slots (in block 307) or alternatively, the requirements of multiple service users may be considered at the same time (e.g. within block 305) and change requests may be sent out in relation to re-allocation of more than one time.

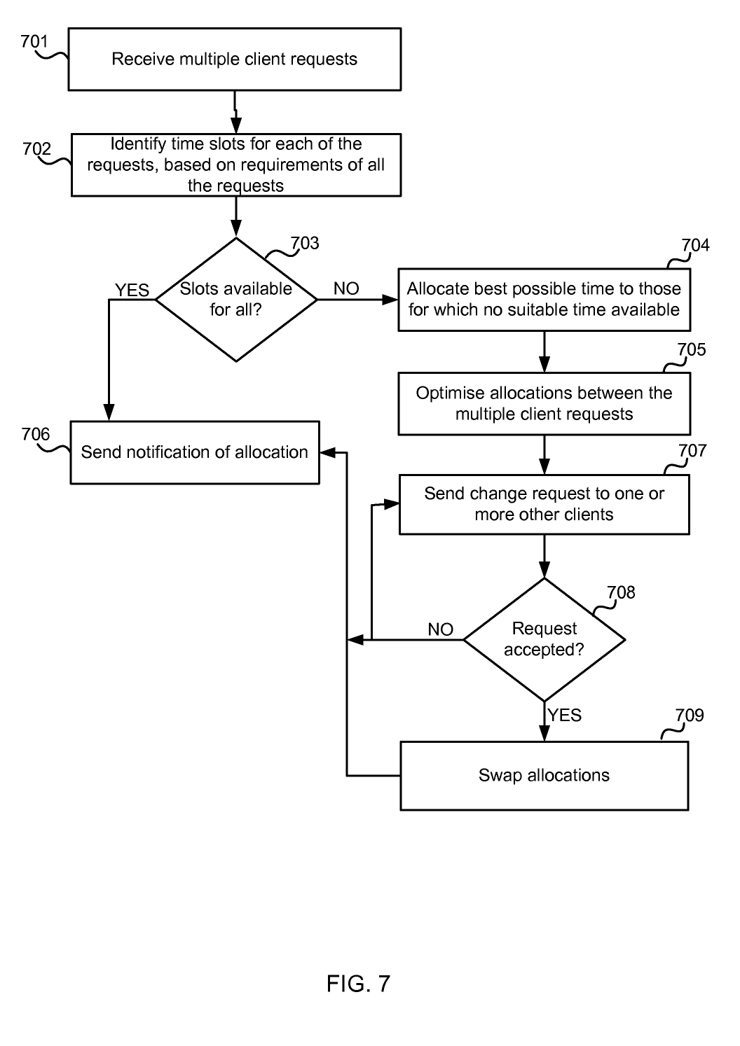

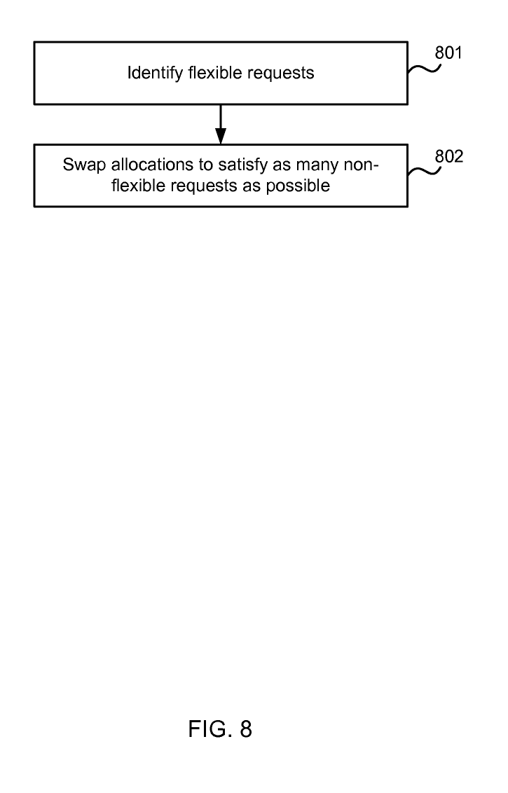

Whilst FIG. 3 shows a single client request (received in block 301) being considered, in some examples, client requests may be handled in batches, as shown in FIG. 7. In such an example, the server may receive multiple client requests (block 701) and process these together. The multiple requests may be received over a defined time period (e.g. an hour or a day) or the batch processing may run once a fixed number of requests have been received (e.g. such that each batch contains ten requests). Other examples may use different parameters to define when the batch processing occurs. When performing the batch processing, time slots are identified to satisfy each of the multiple client requests based on the requirements of the service users (block 702). If one or more of the requests cannot be satisfied (‘No’ in block 703), those requests are allocated the best possible available times (block 704). The allocations for the entire batch of requests may then be optimized (block 705). This optimization may involve, as shown in FIG. 8, identifying those requests within the batch which are flagged as flexible (block 801) and swapping allocations between requests within the batch to satisfy as many non-flexible requests as possible (block 802) or otherwise to reduce one or more cost parameters. In an example, the optimization may minimize the overall cost to all participants (service users and the service provider). Once times have been allocated to each of the requests in the batch (either in block 702 or following the optimization in block 705), notifications are sent to the client applications detailing the allocated time (block 706).

In some examples, existing allocations may also be examined (e.g. in a similar manner to that shown in FIG. 3 and described above). In such an example, following the optimization within the batch (in block 705), change requests may be sent to one or more client applications (block 707) and if a request is accepted (‘Yes’ in block 708), the allocations may be swapped (block 709). The determination of which client applications to send change requests to may be performed as described above with reference to FIG. 6.

Although FIG. 7 does not show the allocations being adjusted in response to a change in circumstances (as in blocks 308-310 of FIG. 3), it will be appreciated that this may occur in some examples.

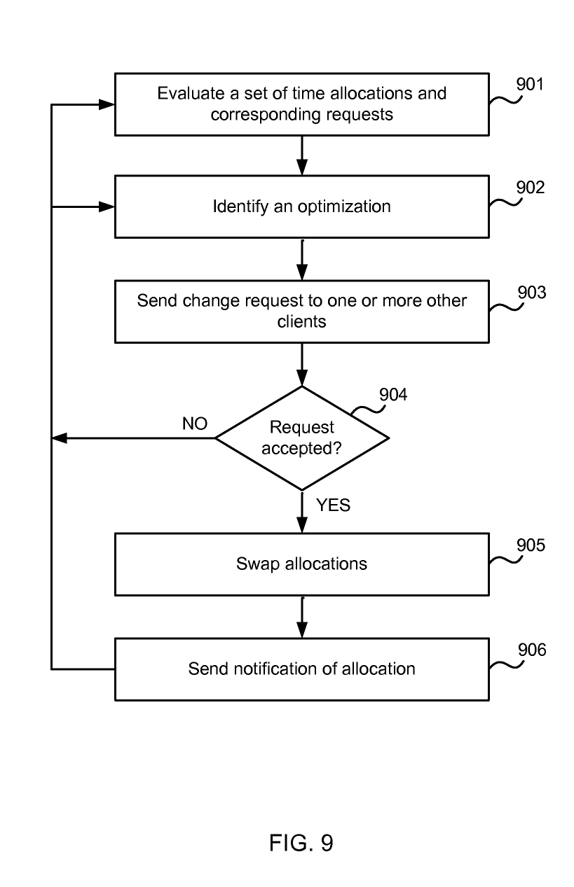

Whilst FIGS. 3 and 7 show allocation of times being adjusted in response to receipt of a new user request, in some examples, the allocation of times may be continuously or periodically adjusted to optimize the allocations for some or all service users and for the service provider, as shown in FIG. 9. As described above, this optimization may be based on one or more cost parameters and may take into consideration the cost to a service user of their time spent waiting in a queue. A set of time allocations and their corresponding requests are evaluated (block 901) and an optimization identified (block 902). The set of time allocations may, for example, correspond to all time allocations, or all allocations in a particular day or week etc. Change requests are sent to those client applications affected by the identified optimization (block 903) and if the change is accepted (‘Yes’ in block 904), the allocated times are swapped (block 905) and the client applications may be notified of their new allocated time (block 906). This process may be repeated, e.g. to consider a new optimization and/or to evaluate a different set of time allocations.

This optimization of time allocations (which may be performed once or repeatedly), even when a new request has not been received, enables the optimization to consider multiple service users who require access to a time based resource and to optimize to best meet their collective requirements whilst also improving the efficiency for the service provider.

The user requirements, as input in block 201, and the resulting user constraints included in the request (sent in block 202), in relation to access to a particular resource may be fixed or may vary. For example, the degree of urgency and/or flexibility may be input initially by the service user and may remain the same; alternatively, the user constraints may vary as a deadline is approached or as the time of the allocated time slot is approached. In an example, a service user may indicate that they are flexible about the scheduling of an opticians appointment as long as they have an appointment before the end of the month. As the end of the month approaches, the urgency rating may be increased and the flexibility reduced. In another example, the requirements may indicate that a requirement is flexible until 24 hours before the allocated time slot, in order to prevent last minute changes which may be inconvenient to the service user. The client application may communicate any change in constraints to the server (e.g. so that they can be taken in to consideration when considering optimizations or changes in response to a new request or change in circumstances) or alternatively, the change in constraints may be used by the client application to determine whether to accept or reject a proposed change (in block 205). In another example, the variability of the constraints may be communicated within the initial user request which is sent by the client application to the server.

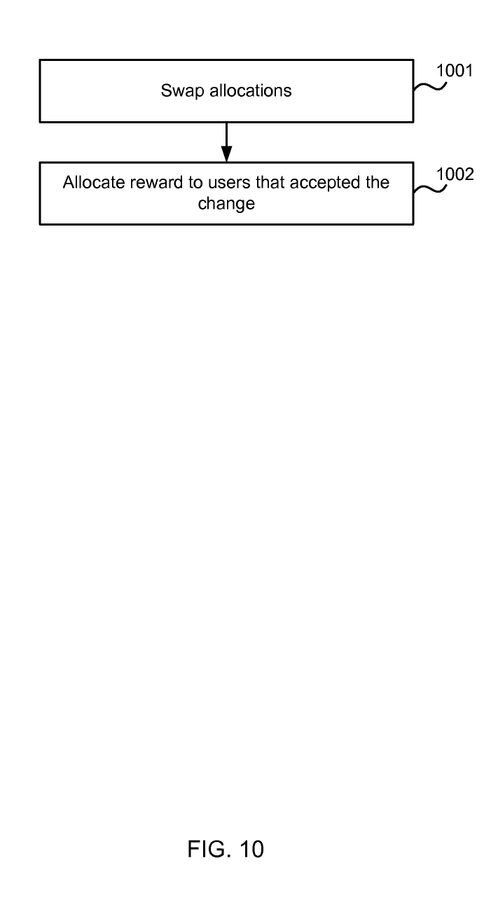

Service users may be rewarded in return for their flexibility. The reward may comprise a discount in a fee charged, a credit for use in obtaining future services, a token for a priority allocation in the future or any other type of reward. As described above, a service user may indicate the reward that they require in order to agree to change their allocated time slot or the reward may be determined by the server. Where the reward is determined by the server, it may be fixed or variable. Factors which may affect a variable reward may include: how close to the allocated time slot the change occurs, the popularity of the time slot, the time of day etc. The allocation of rewards is shown in FIG. 10 which is a flow diagram of an example implementation of one or more of blocks 307, 709 and 905. Having swapped the allocations (block 1001), a reward is allocated to the service users that accepted the change (block 1002). In most cases, a reward will be allocated to one of the parties involved in the swap; however in some instances, such as overall optimizations (as shown in FIG. 9) or when responding to a change in circumstances (as in block 310 of FIG. 3), there may be more than one party which is allocated a reward in return for their flexibility.

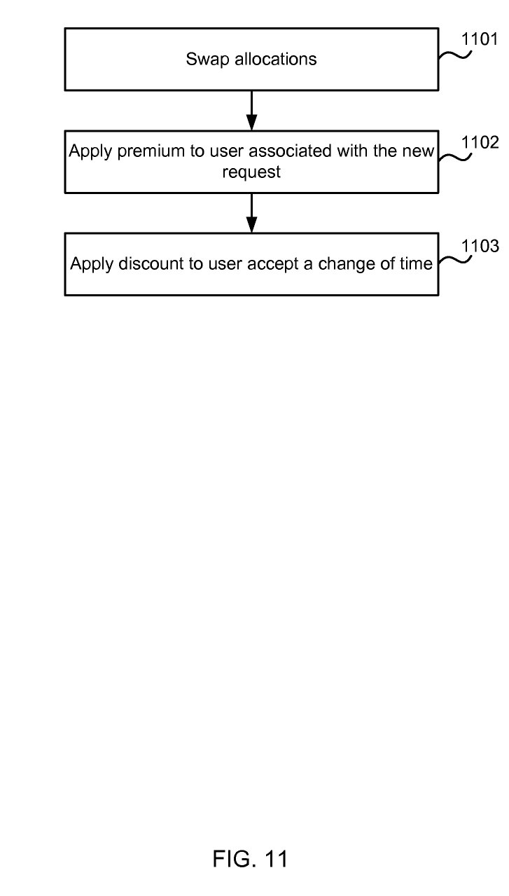

In addition to, or instead of, rewarding service users in return for their flexibility, premiums may be charged to those service users whose request is satisfied by taking the time previous allocated to someone else. This is shown in FIG. 11 which is a flow diagram of an example implementation of one or more of blocks 307, 709 and 905. When allocations are swapped (block 1101), the premium is applied to the service user associated with the new request which has triggered the swap (block 1102) and the discount or other reward is applied to the service user that accepted the change (block 1103). The level of premium applied may be determined by the service provider, by the server or by the service user paying the premium. In an example, the level of discount may be matched to the level of premium charged, so that the overall fee paid by the two service users is not changed.

Whilst FIG. 11 shows both a premium and a discount being applied, in other examples, a premium may be charged without awarding a discount or any other reward for flexibility. Where the change is required by a change in circumstances (e.g. lack of availability of the resource), as described above, a reward may be provided to all service users that change or may not be provided to any of them.

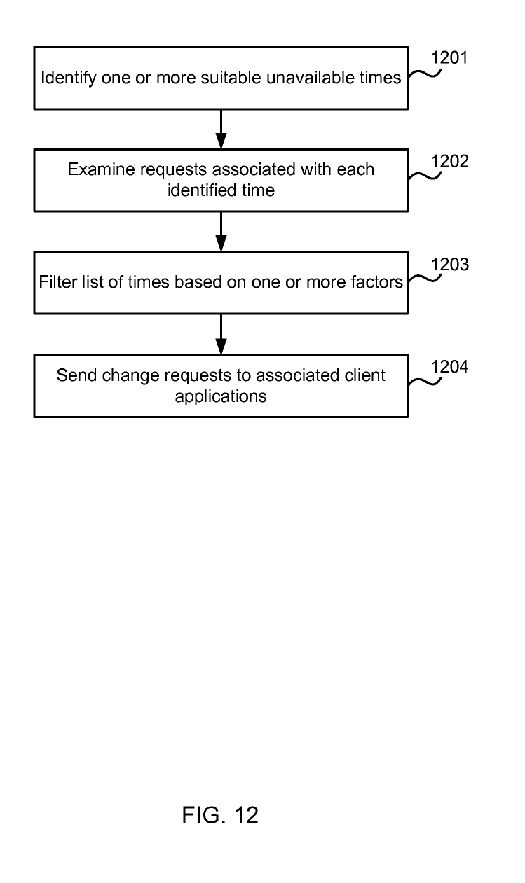

As described above, the user requirements (input in block 201) may indicate a premium which the service user is prepared to pay in order to obtain a desired time allocation or to be prioritized. The user requirements may also specify a discount which is required in return for offering flexibility. In an example, these specified premiums and discounts may be used in determining which client applications are sent change requests (e.g. in blocks 305, 707 or 903), as shown in FIG. 12. When a new request cannot be satisfied by an available time, one or more suitable, but already allocated, times may be identified (block 1201) and the requests associated with each identified time may be examined (block 1202). The list of identified times may then be filtered based on one or more factors in the associated requests (block 1203), where the factors may include one or more of: flexibility indicator, premium stated, discount required, urgency/priority rating etc. Having filtered the list of identified times, change requests are sent to the associated client applications for each of the identified times (block 1204).

In an example, if the particular request (received in block 301 ) indicates a premium which the service user will pay to obtain a suitable time slot, the list of client applications (or one or more identified suitable times) may be filtered (in block 1203) to correspond to those requests that indicated that a change of time would be acceptable in response to a discount which is equal to or smaller than the premium offered in the new request. In this manner, a service provider can demand a premium from one service user and give a discount to another service user without reducing the total amount charged for the two time slots.

In another example, a filter may be based on urgency/priority rating. In such an example, the requests may be filtered to comprise only those with a lower urgency/priority rating than the new request. In a further example, the filter may be based on more than one factor.

In an example, where tokens are rewarded in return for flexibility (as in block 1002), the premium charged for priority (as in block 1102) may be the use of such a token. This use of tokens may be particularly useful where there is no charge for the time based resource (e.g. in publicly funded heath care or other public services) and therefore a discount cannot be used as a reward. In other examples, the tokens which are awarded may be redeemed for other purposes, e.g. in return for gifts etc.

As described above, where there is a change of circumstances in relation to the availability of the time based resource, the time allocations may be changed (as shown in FIG. 3). In some implementations, service user location information may be used to determine whether such a change of circumstances is going to occur. For example, location information relating to a service user may be used to predict when a service user with an allocated time will arrive at the service provider location and as a result may be able to optimize time allocations for other service users. Other information may be used in addition to the location information, such as traffic densities and the speed at which the service user is traveling. The location information may be available from a mobile device carried by the service user which may have GPS capability or location may be determined using another technique (e.g. based on cell tower). This mobile device may be the user device used by the service user to request access to the time based resource (as described above).

In another example, a service user may indicate, via their client application, that they are running late (or early) and this may result in re-arranging allocations to accommodate the change in circumstances and increase the effectiveness of the service provider's time and the time of those using the service provided.

In a further example, a service user may be required to acknowledge a reminder (e.g. as issued in block 207) in order to keep their appointment. Failure to acknowledge may result in a cancellation of the allocated time and trigger optimization of resource allocations due to the change in circumstances.

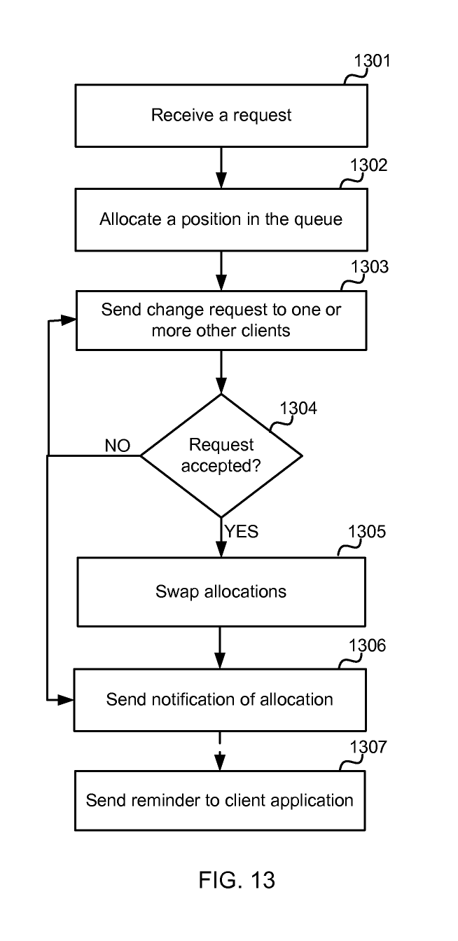

Whilst the above description relates to a time-appointment service provider, the methods are also applicable to an open access service provider. In such an instance, it is a position in the queue, rather than a time, which is allocated to a service user in response to a request (e.g. in block 203) and it is the position in the queue which is swapped between service users. Positions may be allocated using a sequentially increasing number (e.g. in a similar manner to systems which use numbered tickets to manage queues). Through use of the client application, a service user may join a queue remotely (e.g. from home before traveling to the service provider) and the service user may wait until they are closer in time (or position in the queue) to being served before traveling to the service provider. FIG. 13 shows an open access version of a method which corresponds to that shown in FIG. 3 and described above in relation to the time-appointment scenario.

FIG. 13 is a flow diagram of an example method of operation of a server 101. On receipt of a request (block 1301), the server allocates the service user a place in the queue (block 1302). The server then sends change requests to one or more other client applications (block 1303). If none of the change requests are accepted (‘No’ in block 1304), the server may send additional change requests (block 1303) or may notify the client application of the original allocation (block 1306, with the position in the queue as allocated in block 1302). If a change request is accepted by another client application (‘Yes’ in block 1304), the allocated positions in the queue are swapped (block 1305), such that the client application which sent the new request (received in block 1301) has the earlier queue position and the client application which accepted the change takes the most recently allocated queue position (as allocated in block 1302). A notification is sent to the client application detailing the allocated position (block 1306). A notification may also be sent to the other client application confirming the new, swapped allocation (also in block 1306). The process (blocks 1301-1306) may then be repeated when a new request is received from a client application. The server may also send reminders to client applications (block 1307) when their position in the queue approaches the front. For example, a client application may be allocated position 35 and may be notified when the service user allocated position 25 is being served. The notifications may be user configurable.

When a notification is sent to a client application (in block 1306), the notification may include information in addition to the allocated position in the queue. For example, the server may use queuing theory to predict the time at which the service user will arrive at the front of the queue and this information may be communicated to the service user via the client application (e.g. ‘You have been allocated position 35, it is estimated that you will reach the front of the queue at 17.20°).

It will be appreciated that the variations and alternative embodiments shown in FIGS. 4-12 may also be applied to the open access scenario (and to the method shown in FIG. 13). For example, rewards may be offered for flexibility and premiums charged for advancing in the queue. Filters may be used, for example to only request changes in position to those client applications corresponding to requests with a lower urgency/priority rating.

In addition to being applicable to the TA and OA scenarios, the methods described herein are also applicable to other time based resources such as airplanes, trains, buses etc. In such a situation, the time allocated (e.g. in block 304 of FIG. 3) is the time of the particular airplane, train, bus etc on which a ticket is available. In such an example, multiple client applications will be allocated the same time to correspond to number of tickets available on a particular vehicle/airplane. The methods described above enable optimization of the allocation of spaces on flights, trains etc to service users by maximizing efficiency for the service provider and for all the service users collectively (i.e. by reducing the overall cost to those involved). For example, someone with flexibility may be happy to change flights, particularly in return for a discount or other reward, whilst a business person who has no flexibility may be prepared to pay a premium to swap onto an otherwise full flight.

A client application running on a user device may be used to identify requirements in relation to more than one service provider. The different service providers may all use the same server 101 to perform resource management, or alternatively the client application may communicate with different servers according to the particular time based resource required by the service user.

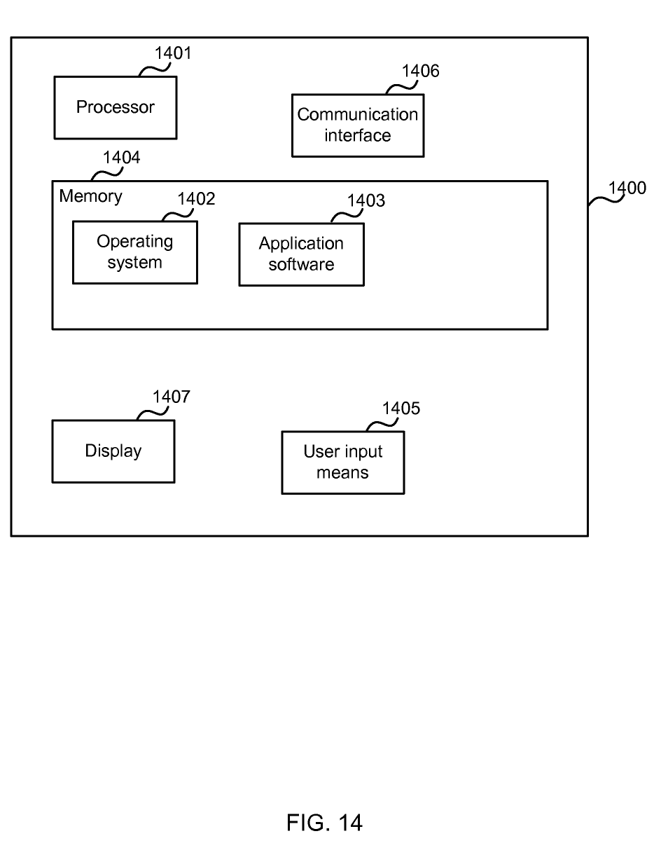

FIG. 14 illustrates various components of an exemplary computing-based device 1400 which may be implemented as any form of a computing and/or electronic device, and in which embodiments of the methods described herein may be implemented. In particular the exemplary computing-based device 1400 may be a user device.

Computing-based device 1400 comprise one or more processors 1401 which may be microprocessors, controllers or any other suitable type of processors for processing computing executable instructions to control the operation of the device in order to send requests for access to a time based resource and to evaluate any change requests received. Platform software comprising an operating system 1402 or any other suitable platform software may be provided at the computing-based device to enable application software 1403, such as the client application described above, to be executed on the device.

The computer executable instructions may be provided using any computer-readable media, such as memory 1404. The memory is of any suitable type such as random access memory (RAM), a disk storage device of any type such as a magnetic or optical storage device, a hard disk drive, or a CD, DVD or other disc drive. Flash memory, EPROM or EEPROM may also be used.

The computing-based device 1400 also comprises a user input means 1405 (such as a keyboard, touch sensitive screen, voice recognition module etc) and a communication interface 1406 to enable communication with the server over a network. The device 1400 may also comprise a display 1407 or an output to a display in communication with the computing-based device. The display may provide a graphical user interface, or other user interface of any suitable type.

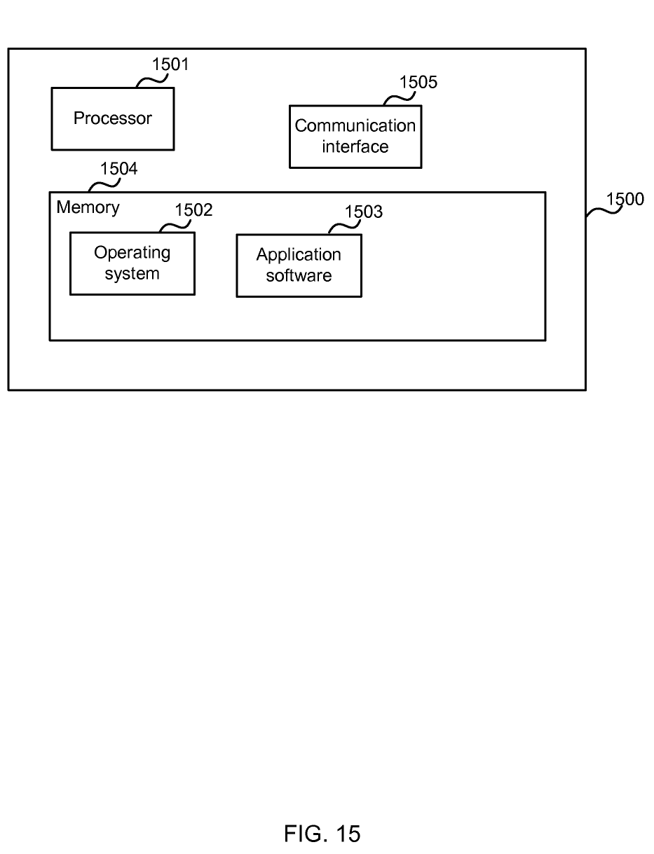

FIG. 15 illustrates various components of an exemplary computing-based device 1500 which may be implemented as any form of a computing and/or electronic device, and in which embodiments of the methods described herein may be implemented. In particular the exemplary computing-based device 1500 may be a server.

Computing-based device 1500 comprise one or more processors 1501 which may be microprocessors, controllers or any other suitable type of processors for processing computing executable instructions to control the operation of the device in order to manage time based resources for one or more service providers. Platform software comprising an operating system 1502 or any other suitable platform software may be provided at the computing-based device to enable application software 1503 to be executed on the device.

The computer executable instructions may be provided using any computer-readable media, such as memory 1504. The memory is of any suitable type such as random access memory (RAM), a disk storage device of any type such as a magnetic or optical storage device, a hard disk drive, or a CD, DVD or other disc drive. Flash memory, EPROM or EEPROM may also be used.

The computing-based device 1500 also comprises a communication interface 1505 to enable communication with user devices over a network. The communication interface 1505 may also be used to access calendar data for the one or more service providers or alternatively this data may be stored within the memory 1504.

The computing-based device 1500 may also comprise one or more inputs and one or more outputs (not shown in FIG. 15). For example, the device 1500 may comprise an output to a display, which may be integral to or connected to the computing-based device 1500 and which provides a graphical user interface or other form of user interface.

Although the present examples are described and illustrated herein as being implemented in a client-server system, the system described is provided as an example and not a limitation. As those skilled in the art will appreciate, the present examples are suitable for application in a variety of different types of computing systems and may, for example, operate on a server which provides a web interface through which service users can interact.

The term ‘computer’ is used herein to refer to any device with processing capability such that it can execute instructions. Those skilled in the art will realize that such processing capabilities are incorporated into many different devices and therefore the term ‘computer’ includes PCs, servers, mobile telephones, personal digital assistants and many other devices.

The methods described herein may be performed by software in machine readable form on a tangible storage medium. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description of a preferred embodiment is given by way of example only and that various modifications may be made by those skilled in the art. The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention.

1. A computer implemented method comprising:
receiving a request to access a resource from a first user device, the request comprising at least one user constraint;
allocating access to the resource;
optimizing allocations to the resource across multiple requests; and
sending a notification of the allocated access.

2. A method according to claim 1, wherein the allocated access comprises one of a time and a position in a queue.

3. A method according to claim 1, wherein allocating access to the resource comprises:
identifying and allocating an available access time which satisfies the at least one user constraint; and
if no access time is available which satisfies the at least one user constraint, allocating an available access time which does not satisfy the at least one user constraint.

4. A method according to claim 3, wherein optimizing allocations to the resource across multiple requests comprises:
sending a message to at least one user device requesting a change of allocated access time; and
on receipt of a message from a user device accepting the change, swapping the allocated access times of the user device accepting the change and the first user device.

5. A method according to claim 4, wherein sending a message to at least one user device requesting a change of allocated access time comprises:
identifying an unavailable access time which satisfies the at least one user constraint;
accessing a request associated with the unavailable access time, the request originating from a second user device; and
if the request comprises a flexibility indicator, sending a message requesting a change of allocated access time to the second user device.

6. A method according to claim 4, wherein swapping the allocated access times of the user device accepting the change and the first user device comprises:
swapping the allocated access times of the user device accepting the change and the first user device; and
allocating a reward to the user device accepting the change.

7. A method according to claim 6, wherein swapping the allocated access times of the user device accepting the change and the first user device further comprises:
applying a premium to the first user device.

8. A method according to claim 4, wherein sending a message to at least one user device requesting a change of allocated access time comprises:
identifying a plurality of unavailable access times which satisfies the at least one user constraint;
accessing a request associated with each of the plurality of unavailable access times, each request originating from a user device;
filtering the plurality of unavailable access times based on the requests and at least one factor; and
sending a message requesting a change of allocated access time to a user device associated with each of the filtered plurality of unavailable access times.

9. A method according to claim 3, wherein identifying and allocating an available access time which satisfies the at least one user constraint comprises:
accessing electronic calendar data associated with a provider of the resource; and
based on the electronic calendar data and the at least one user constraint, identifying and allocating an available access time which satisfies the at least one user constraint.

10. A method according to claim 1, wherein receiving a request to access a resource from a first user device, the request comprising at least one user constraint comprises:
receiving a request to access a resource from each of a plurality of user devices;
and wherein allocating access to the resource comprises:
for each request, identifying and allocating an available access time which satisfies the at least one user constraint; and
for each request where no access time is available which satisfies the at least one user constraint, allocating an available access time which does not satisfy the at least one user constraint.

11. A method according to claim 10, wherein optimizing allocations to the resource across multiple requests comprises:
identifying requests comprising a flexibility indicator; and
changing allocated access times for said identified requests.

12. A method according to claim 11, wherein optimizing allocations to the resource across multiple requests further comprises:
sending a message to at least one user device not in the plurality of user devices requesting a change of allocated access time; and
on receipt of a message from a user device accepting the change, swapping the allocated access times of the user device accepting the change and one of the plurality of user devices.

13. A method according to claim 1, further comprising, in response to a change in circumstances in relation to the resource or a user of the resource:
identifying one or more affected user devices; and
sending a message to each affected user device requesting a change of allocated access.

14. A method according to claim 13, wherein the change in circumstances in relation to the resource or a user of the resource is identified based on user location information.

15. A method according to claim 1, further comprising:
evaluating a plurality of access allocations and corresponding requests;
identifying an optimization within the plurality of access allocations and corresponding requests;
sending a message to each user device affected by the optimization requesting a change of allocated access time; and
on receipt of a message accepting the change from each user device affected by the optimization, implementing the optimization.

16. One or more tangible device-readable media with device-executable instructions for performing steps comprising:
on receipt of a user input detailing a user requirement for access to a resource, sending a request for access to a service provider, the request comprising at least one user constraint determined using the user requirement; and
receiving notification of an access allocation from the service provider.

17. One or more tangible device-readable media according to claim 16, further comprising device-executable instructions for performing steps comprising:
on receipt of a message from the service provider requesting a change in access allocation, evaluating the change requested; and
sending a message to the service provider indicating one of acceptance and rejection of the change.

18. One or more tangible device-readable media according to claim 16, further comprising device-executable instructions for performing steps comprising:
generating a reminder for a service user of the access allocation.

19. One or more tangible device-readable media according to claim 16, wherein sending a request for access to a service provider comprises:
accessing electronic calendar data associated with the service user;
generating a user constraint based on the electronic calendar data and the user requirement; and
sending the request to the service provider comprising the user constraint.

20. One or more tangible device-readable media with device-executable instructions for performing steps comprising, in response to a user request for access to a resource from a first user device which cannot be satisfied by an available access time:
allocating an available access time;
sending a message to a second user device requesting a change in allocated access time; and
on receipt of an acceptance message from the second user device, swapping the allocated times for the first and second user devices.
